(19) United States
(12) Patent Application Publication
(10) Pub. No.: US 2008/0045660 A1
(43) Pub. Date: Feb. 21, 2008

(54) Thermoplastic Olefin Compositions

(76) Inventors: Jerry Wayne Rodrigue, Missouri City, TX (US); Donald T. Robertson, Wichita, KS (US); Amitkumar Dharia, Coppell, TX (US)

Correspondence Address: BUSKOP LAW GROUP, P.C., 4511 Dacoma Street, HOUSTON, TX, 77092, US

(21) Appl. No.: 11/924,050

(22) Filed: Oct. 25, 2007

Related U.S. Application Data
(63) Continuation-in-part of application No. 11/768,050, filed on Jun. 25, 2007.
Application No. 11/768,050 is a division of application No. 10/757,982, filed on Jan. 14, 2004, now Pat. No. 7,235,609.

(51) Int. Cl. C08J 3/24

(52) U.S. Cl. 525/194

(57) ABSTRACT

A thermoplastic olefin composition comprising: from about 50 percent to about 90 percent by weight of polyolefins consisting of a substantially linear copolymer or homopolymer of propylene and a long chain branched linear copolymer or homopolymer of propylene; from about 10 percent to about 50 percent by weight of a cross linkable alpha-olefin polymer elastomer; and a thermally decomposing free radical generating agent. The composition is formed by combining the components at a temperature sufficient to melt the polyolefins and elastomer and thermally decompose the free radical generating agent.

### CROSS REFERENCE TO RELATED APPLICATIONS

This patent application is a continuation-in-part application that claims the benefit, under 35 USC §120, of the prior non-provisional application having Ser. No. 11/768,050, filed Jun. 25, 2007, which is a divisional application that claims priority to the application having Ser. No. 10/757,982, filed Jan. 14, 2004, now issued U.S. Pat. No. 7,235,609. The prior co-pending non-provisional applications are incorporated by reference along with their appendices.

### FIELD

The present embodiments relate to compositions for thermoplastic olefins useable to form shaped articles.

### BACKGROUND

A need exists for a thermoplastic olefin composition well suited for the manufacture of larger surface, deep parts.

A further need exists for a thermoplastic olefin having sufficient melt strength and drawability to withstand thermoforming of large items. Thermoforming includes heating a polymer sheet until it is softened, stretching the sheet over a solid mold having a desired part shape, and allowing the sheet to cool until rigid, so that it retains the shape and detail of the mold.

A need also exists for a thermoplastic olefin composition having a sufficient melt flow rate to allow molding of large parts that lack surface defects, without detracting from the necessary drawability of the polymer.

A need exists for a thermoplastic olefin composition that does not experience shrinkage, loss of gloss, color change, brittleness, or deformation after thermoforming, which can be detriment for use on many surface parts of automobiles or appliances.

Accordingly, the art has continued to search for a cost effective solution that balances processability and thermo-formability of a thermoplastic composition with desired mechanical properties of articles formed from the compositions.

The present embodiments meet these needs.

### DETAILED DESCRIPTION OF THE EMBODIMENTS

Before explaining the present composition in detail, it is to be understood that the apparatus is not limited to the particular embodiments and that it can be practiced or carried out in various ways.

The present embodiments relate to a thermoplastic olefin composition, useful for the manufacture of numerous durable articles, such as automotive dash boards and bumper fascia, appliance housings, walls, floors, and ceilings of recreational vehicles and transportation vehicles.

The present composition advantageously combines a high melt strength with high drawability, forming a polymer that can withstand the thermoforming of large surface, deep parts, where conventional polymers can break due to low dimensional strength or drawability. Thermoformed articles, and articles formed from other processes, made using the present composition, have high stiffness and impact strength, especially low temperature impact strength, without requiring use of difficult and costly components.

The present composition is recyclable. Thermoformed articles, and articles formed from other processes, using the present composition, can be trimmed, and the trim can be recovered, reground, and re-processed, reducing the cost of the fabrication of articles and the consumption of natural resources.

High stability, and no shrinkage or loss of gloss after thermoforming, which can be a large detriment when forming many surface parts for automobiles, appliances, structures, and other objects, is exhibited by the present composition. The present composition exhibits a long shelf life, and can be stored in the form of sheets or pellets for at least three years or longer without discoloration, brittleness, or deformation.

The present composition provides a less expensive, lightweight composition, having a higher impact strength than conventional polystyrene, polyvinylchloride, and similar polymers. The present composition is environmentally friendly and recyclable.

The present composition is beneficially useable in a wide variety of applications, including thermoforming, blow molding, melt blending, injection molding, compression molding, foaming, and other similar methods for forming and shaping articles. The present composition exhibits high strength and drawability independent of the method used to form articles. The present composition exhibits good flow properties while retaining high tensile strength and toughness.

The present composition further provides the benefit of multiple useable free radical generating agents that avoid beta-scission and cross-linking of the resulting thermoplastic olefin. Polymers containing tertiary hydrogen, such as polystyrene, polyethylene copolymers, and particularly polypropylene, have secondary and tertiary backbone carbon-hydrogen bonds that can react. Beta-scission of the polymer backbone occurs preferentially when secondary hydrogen atoms are abstracted, resulting in lower molecular weights, higher melt flow rates, and decreased viscosity. Because beta-scission is not uniform, molecular weight distribution increases as lower molecular weight polymer chains are formed. Additionally, chain scission can allow free radicals to cause cross-linking of the dispersed elastomer, increasing viscosity and weakening adhesion, resulting in poor processability, surface finish, tear strength, and dimensional stability. The free radical generating agents of the present composition avoid these disadvantages.

The present thermoplastic olefin composition possesses a three-dimensional structure having high stability, drawability, and impact strength that does not rely on cross-linking, resulting in a polymer that is not subject to the disadvantages of weak adhesion created due to uncontrolled oxidation, cross-linking, and chain cleavage.

The present thermoplastic olefin composition can include from more than 50 percent to about 90 percent by weight of polyolefins. The polyolefins can include a mixture of a substantially linear homopolymer or copolymer of propylene and a long chain branched liner homopolymer or copolymer of propylene. The term “linear” is defined herein as identifying a polymer chain which is predominantly free of long chain branching. “Long chain branched” or “long chain branching” herein characterizes branching within polymeric structures which exceeds short branch lengths of pendant groups derived from individual alpha-olefin co-monomers.

The polyolefins can include one or more C₂-C₁₀ alpha-olefins. It is contemplated that in an embodiment, the substantially linear polymer or copolymer can be present in an amount ranging from about 20 percent to about 85 percent by weight, and the long chain branched polymer can be present in an amount ranging from about 5 percent to about 20 percent by weight.

The substantially linear polymer can include thermoplastic polymers from the polymerization of mono-olefin monomers having from about 2 carbon atoms to about 10 carbon atoms by a high pressure, low pressure, or intermediate pressure process, by Ziegler-Natta catalysts, or by metallocene catalysts. The substantially linear polymer can have any tacticity, and can be a homopolymer, a copolymer, a cross-linked polymer, an amorphous polymer, a crystalline polymer, or combinations thereof. The preferred monomer is propylene. Preferably, the mono-olefin monomers converted to repeat units are at least 99 percent propylene, based on less than 1 percent xylene extractables. The polypropylene can be a homopolymer, a reactor copolymer polypropylene, isotactic polypropylene, syndiotactic polypropylene, and other propylene copolymers. Desirably, the polypropylene has a melting temperature peak of at least 160 degrees Centigrade, suitably about 165 degrees Centigrade, and a heat of fusion of greater than 65 J/g.

The substantially linear polymer can have nominal melt flow rates of from about 0.5 to about 12 or higher g/10 minutes at 230 degrees Centigrade, preferably from about 0.5 to about 4 g/10 minutes at 230 degrees Centigrade, and more preferably from about 1 to about 2.5 g/10 minutes at 230 degrees Centigrade. Most preferably, the substantially linear polymer will have a melt flow rate close to that of the long chain branched olefin. For example, the substantially linear polymer and the long chain branched polymer can both have a melt flow rate of about 3 g/10 minutes at 230 degrees Centigrade.

Preferred long chain branched polymers include polypropylene homopolymers and copolymers. A long chain branch of polypropylene should have at least a sufficient number of carbon atoms to provide significant modifications in Theological behavior, as measured by melt strength or melt tension, such as caused by chain entanglement. The minimum number of carbon atoms in a long chain branch is usually greater than about 100. Short chain branching introduced through co-monomer polymerization provides branch lengths of usually less than about 10 carbon atoms per branch.

The long chain branched polymer can be formed from propylene, polypropylene, or combinations of these polymers. Preferably, the mono-olefin monomers converted to repeat units are at least 99 percent propylene (based on xylene extractables). A suitable long chain branched polymer is Daploy™ WB130HMS, manufactured by Borealis A/S, which has an I_{10/12} of about 20 and a melt tension of about 36 cN@190 degrees Centigrade.

Long chain branched propylene polymers can be synthesized by known free radical coupling reactions, such as modification of propylene homopolymers and/or copolymers with ionizing radiation or thermally decomposing free radical-forming agents, such as peroxides, with addition of multifunctional, ethylenically or butylenically unsaturated monomers. Long chain branched propylene homopolymers and/or copolymers can also be synthesized by the polymer-like reaction of functionalized polyalpha-olefin homopolymers and/or copolymers, such as propylene homopolymers and/or propylene copolymers containing acid groups and/or acid anhydride groups, with multifunctional compounds of opposite reactivity, suitably with C₂ to C₁₆ diamines and/or with C₂ to C₁₆ diols.

Examples of long chain branched propylene homopolymers and/or copolymers produced by polymer-like reactions include polymers produced by the reaction of maleic anhydride-grafted polyalpha-olefin homopolymers and/or copolymers with diamines or polyglycols, or by the reaction of polyalpha-olefin homopolymers and/or copolymers containing acid or acid anhydride groups with polymers containing epoxy, hydroxy or amino groups. Further, long chain branched homopolymers and/or copolymers can include those synthesized by the hydrolytic condensation of polyalpha-olefin homopolymers and/or copolymers, which contain hydrolyzable silane groups.

In an embodiment, it is contemplated that the present composition can include from about 30 percent to about 85 percent by weight of substantially linear polymer and long chain branched polymer, preferably from about 45 percent to about 72 percent by weight, and more preferably from about 57 percent to about 72 percent by weight, based on the total weight of the thermoplastic olefin composition. The substantially linear polymer can be present in an amount ranging from about 50 percent to about 90 percent by weight, preferably from about 60 percent to about 80 percent by weight, and more preferably from about 70 percent to about 80 percent by weight. The long chain branched polymer can range from about 5 percent to about 20 percent by weight, preferably from about 8 percent to about 15 percent by weight, and more preferably from about 8 percent to about 13 percent by weight.

The present composition can further include from about 10 percent to less than about 50 percent by weight of a cross-linkable alpha-olefin polymer elastomer. The alpha-olefin polymer elastomer can be an ethylene alpha-olefin polymer elastomer, a propylene alpha-olefin polymer elastomer, a butylene alpha-olefin polymer elastomer, or combinations thereof.

The elastomer can be any elastomer including at least a small percentage of unsaturated double bond sites that are susceptible to cross-linking. While the elastomer is characterized as capable of cross-linking, it is not implied that the reaction which the elastomer undergoes in the process of forming the present thermoplastic olefin includes cross-linking, only that cross-linking is possible because of unsaturated double bond sites in the elastomer. Ethylene alpha-olefin polymers are a suitable elastomeric component and can include interpolymers and diene modified interpolymers.

The term “interpolymer” refers to a copolymer having polymerized therein at least two monomers, and can include copolymers, terpolymers, and tetrapolymers. Interpolymers can further include polymers prepared by polymerizing ethylene, propylene, or butylene with at least one co-monomer, typically an alpha-olefin of about 3 carbon atoms to about 20 carbon atoms, and preferably ranging from about 3 carbon atoms to about 10 carbon atoms. Exemplary alpha-olefins include propylene, 1-butene, 1-hexene, 4-methyl-1-pentene, 1-heptene, 1-octene, and styrene.

Illustrative polymers include ethylene/propylene (“EP”) copolymers, ethylene/butylene (“EB”) copolymers, and ethylene/octene (“EO”) copolymers. Preferred copolymers include EP, EB, ethylene/hexene-1 and EO polymers. Illustrative terpolymers include ethylene/propylene/octene terpolymers, terpolymers of ethylene, a C₃-C₂₀ alpha-olefin, and a diene, such as dicyclopentadiene, 1,4-hexadiene, piperylene, or 5-ethylidene-2-norbornene (“ENB”). Ethylene/propylene/diene modified terpolymers are conventionally referred to as “EPDM” compounds.

Suitable EPDM's, including ENB, have a molecular weight distribution greater than 4, a Mooney viscosity ranging from about 25 to about 100 (ML100C+4), preferably from about 55 to about 70, a low to medium ENB content of from about 0.5 mol % to about 3 mol %, preferably from about 0.5 mol % to about 2 mol % ENB, and an ethylene content from about 65 percent to about 80 percent, preferably from about 60 percent to about 70 percent.

More specific EAO examples include ultra low linear density polyethylene (ULDPE), such as Attane™, made by The Dow Chemical Company, homogeneously branched, linear EAO copolymers, such as Tafmer™, made by Mitsui Petrochemicals Company, Ltd. and Exact™, made by Exxon Chemical Company, and homogeneously branched, substantially linear EAO polymers, such as Affinity™ polymers, available from The Dow Chemical Company, Engage® polymers, available from DuPont Dow Elastomers, L.L.C., and Buna® EP copolymers, available from Bayer Material Sciences. Suitable EAO polymers can include homogeneously branched linear and substantially linear ethylene copolymers with a density (measured in accordance with ASTM D-792) of from about 0.85 g/cm³ to about 0.92 g/cm³, especially from about 0.85 g/cm³ to about 0.90 g/cm³, and a melt index or 12 (measured in accordance with ASTM D-1238 (190.degree. C./2.16 kg weight) of from about 0.01 g/10 min to about 30 g/10 min, preferably 0.05 g/10 min to 10 g/10 min.

Desirably, the elastomer is from about 10 to about 50, more desirably from about 20 to about 40, and preferably from about 20 to about 30 weight percent of the thermoplastic olefin composition of this invention.

The present composition can also include a thermally decomposing free radical generating agent. It is contemplated that the thermally decomposing free radical generating agent is selected from compounds that do not materially degrade homopolymer or copolymers of a C₂-C₁₀ olefin.

The thermally decomposing free radical generating agent can include a peroxide, an alkyl peroxide, a dialkyl peroxide, a persulfate, a percarbonate, an azo compound of the general formula R₁—N═N—R₂, or combinations thereof. R₁ and Rₑ can be the same or different alkane groups, such as an azoalkane, which can include an azosilane, azonitrile, or alpha-carbonyl azo compound.

It is contemplated that when an azo compound is used as the free radical generating a gent, the azo compound is not used in an amount exceeding 1.0 phr of elastomer, and preferably less than 0.5 phr of elastomer. It should be understood that “phr” means parts per 100 parts of the elastomer components.

The use of azo compounds is unique in that azo compounds do not cause material scission of the olefin polymer backbone, thus preventing a decrease in viscosity. The use of azo compounds further does not cause sufficient cross-linking of the elastomer, but instead effects depression in polymer crystallinity, improving formability and ductility. Use of azo compounds also reduces size of crystalline domains, thereby reducing shrinkage, warpage, and surface roughness, which improves gloss.

The free radical generating compounds that do not significantly degrade the molecular weight of thermoplastics used in the thermoplastic olefin composition of this invention are desirably from about 0.1 phr to about 1.0 phr, preferably from about 0.1 phr to about 0.5 phr, and more preferably from about 0.2 phr to about 0.3 phr of the elastomer components used in the thermoplastic olefin composition.

Free radical generating agents are employed in the melt blending process of this invention to cross link the elastomer component of the composition and to graft the thermoplastic components to the elastomer. Free radical generating compounds useful in this invention are ones that do not significantly degrade the molecular weight of thermoplastics. Radicals generated from peroxide compounds tend to possess higher energy and, therefore, tend to be more aggressive and less discriminating in their reactions, attacking both secondary and tertiary backbone hydrogen atoms in polymers containing secondary and tertiary hydrogen atoms, such as polystyrene, polypropylene, polyethylene copolymers, and others, but especially polypropylene, thereby causing beta-scission of the polymer backbone preferentially when secondary hydrogen atoms are abstracted, since the resulting secondary radicals are significantly less stable than tertiary radicals.

It is also well-known that organic peroxide compounds can themselves be decomposed by free radicals. Hydroperoxides, such as tert-butyl hydroperoxide, are particularly prone to radical-induced decomposition. The potential for self-induced decomposition causes peroxides to be shock-sensitive with the risk of explosion, presenting manufacturing plant safety issues. During reactive blending of thermoplastic olefins, as free radicals are liberated to effect reactive blending, some of these radicals can react with un-decomposed peroxide molecules, causing them to decompose prematurely. The results of premature peroxide decomposition during thermoplastic olefin reactive blending can include off-specification product, increased tendency toward polymer backbone scission due to undesirable locally high radical concentrations, and the potential for uncontrolled peroxide decomposition leading to process upsets and possibly process safety problems.

Azo compounds are therefore especially useful with the invention. The term “azo compounds” refers to compounds of the general formula R₁—N═N—R₂, in which R₁ and R₂ can be the same or different organic groups. Azoalkanes are preferred.

Azoalkanes decompose by scission of the C—N bonds, liberating one molecule of nitrogen gas and two carbon-centered radicals. The thermodynamic stability of oxygen-centered radicals is less than the thermodynamic stability of carbon-centered radicals. Hence, oxygen-centered radicals, such as those generated from organic peroxides, are more energetic than carbon-centered radicals, such as those generated from azoalkanes. The less energetic radicals derived from azoalkanes are believed to more selectively abstract tertiary hydrogen atoms from the polymer backbone. Therefore, degradation of the polymer backbone is reduced significantly, qualifying azo compounds as free radical generating compounds that do not significantly degrade the molecular weight of thermoplastics used in the composition of this invention.

Further, although as a compound class azoalkanes undergo thermal degradation, as do organic peroxides, azoalkanes are generally not subject to radical-induced (self-induced) decomposition, and are generally not shock-sensitive. This is particularly true of azonitriles. Hence, the chance of catastrophic decomposition of a stored azoalkane, leading to fire or detonation, is smaller than with most organic peroxide compounds. This enhanced product safety allows administrative and engineering controls for safely storing and handling azoalkanes to be less stringent and burdensome than for peroxides.

In the nomenclature used herein, the term “azoalkane” includes a number of different subclasses of compounds possessing the azo functional group (R₁—N═N—R₂), including azosilanes, azonitriles, and alpha-carbonyl azo compounds. Azoaromatics, such as azobenzene, are not included, however.

Examples of azo compounds useful in this invention include, without limitation, the following: 1-cyano-1-(t-butylazo)cyclohexane; 1-(tert-amylazo)-cyclohexanecarbonitrile; 1-(tert-butylazo)-cyclohexanecarbonitrile; 1-(tert-butylazo)-formamide; 1,1′-azo-bis(cyclohexanecarbonitrile); 1,1′-azo-bis-cyclohexane nitrile; 1,1′-azo-bis-cyclopentane nitrile; 2-(tert-butylazo)isobutyronitrile; 2-(tert-butylazo)-2,4-dimethylpentanenitrile; 2-(tert-butylazo)-2-methylbutanenitrile; 2-(tert-butylazo)-4-methoxy-2,4-dimethylpentanenitrile; 2,2′-azobis(2,4-dimethylpentanenitrile); 2,2′-azobis(2-acetoxypropane); 2,2′-azobis(2-ethylpropanimidamide).2HCl; 2,2′-azobis(2-methyl-butanenitrile); 2,2′-azobis(isobutyronitrile); 2,2′-azo-bis-methyl-2-methyl propionate; 2,2′-azo-bis-2-methylpropionitrile; 2,2′-azo-bis-cyclohexyl propionitrile; 2-cyano-2-propylazoformamide; 4-(tert-butylazo)-4-cyanopentanoic acid; 4,4′-azobis(4-cyanopentanoic acid); azo-bis-(N,N′-diethyleneisobutyramidine); azodicarbonamide; N,N′-dichloroazodicarbonamide; azo dicarboxylic acid diethyl ester; azo bis(isobutyronitrile); and combinations thereof.

Particularly preferred azoalkanes are azodicarbonamide and 1,1′-azobis(cyclohexanecarbonitrile) (“ACCN”). ACCN is a solid azoalkane and is the azo compound used in the examples incorporated herein.

In an embodiment, it is contemplated that an organic peroxide free radical generator is not used unless, and only if, it is present in combination with an azo compound, and then only if the amount of the free radical generator used is not in excess of the azo compound by more than 50 percent, and preferably does not exceed the amount of azo compound used. Preferably, the organic peroxide compound is used in the range from about 0.15 phr to about 0.25 phr of elastomer.

Accordingly, while peroxides are not preferred because of the handling difficulties they present, if used in combination with an azo compound, peroxides that can be used include, without limitation, a series of vulcanizing and polymerization agents that contain alpha,alpha′-bis(t-butylperoxy)-diisopropylbenzene that are available from Hercules, Inc. under the trade designation VULCUP™, a series of such agents that contain dicumyl peroxide and are available from Hercules, Inc. under the trade designation Di-cup™, Lupersol™ peroxides made by Elf Atochem, North America, and Trigonox™ organic peroxides made by Akzo Nobel.

Lupersol™ peroxides include Lupersol™ 101 (2,5-dimethyl-2,5-di(t-butylperoxy)hexane), Lupersol™ 130 (2,5-dimethyl-2,5-di(t-butylperoxy)hexyne-3) and Lupersol™ 575 (t-amyl peroxy-2-ethylhexonate). Other suitable peroxides include 2,5-dimethyl-2,5-di-(t-butyl peroxy)hexane, di-t-butylperoxide, di-(t-amyl)peroxide, 2,5-di(t-amyl peroxy)-2,5-dimethylhexane, 2,5-di-(t-butylperoxy)-2,5-diphenylhexane, bis(alpha-methylbenzyl)peroxide, benzoyl peroxide, t-butyl perbenzoate, 3,6,9-triethyl-3,6,9-trimethyl-1,4,7-triperoxonane, and bis(t-butylperoxy)-diisopropylbenzene.

The substantially linear polymer and the long chain branched linear polymer of the present invention can include homopolymers or copolymers. That is, the substantially linear polymer could be a homopolymer while the long chain branched linear polymer is a copolymer, the substantially linear polymer could be a copolymer while the long chain branched linear polymer is a homopolymer, both the substantially linear polymer and the long chain branched linear polymer can be copolymers, or both the substantially linear polymer and the long chain branched linear polymer can be homopolymers.

In an embodiment, the thermoplastic olefin compositions of the present invention can be compounded with conventional additives or process aids, such as thermal stabilizers, ultraviolet stabilizers, flame retardants, mineral fillers, extender or process oils, conductive fillers, nucleating agents, dispersants, plasticizers, impact modifiers, colorants, mold release agents, lubricants, antistatic agents, pigments, other similar additives, and combinations thereof.

Suitable mineral fillers can include, but are not limited to talc, ground calcium carbonate, precipitated calcium carbonate, precipitated silica, precipitated silicates, precipitated calcium silicates, pyrogenic silica, hydrated aluminum silicate, calcined aluminosilicate, clays, mica, wollastonite, and combinations thereof.

Extender oils are often used to reduce one or more of viscosity, hardness, modulus, and cost of a composition. The most common extender oils have particular ASTM designations depending upon whether the extender oils are classified as paraffinic, naphthenic, or aromatic oils. The extender oils, when used, are desirably present in an amount within a range of about 10 phr to about 80 phr of polymers, based on total composition weight.

The present composition is contemplated to be formed by combining the components at a temperature sufficient to melt the polyolefins and elastomer and thermally decompose the thermally decomposing free radical generating agent. It is contemplated that the combining of the components can include melt blending, heating, molding, mixing of the components, or combinations thereof.

The thermal decomposition of the free radical generating agent results in thermoplastic olefins which exhibit unexpectedly high impact strength at room and subzero temperatures, that can be extruded into thick sheet or thermoformed into deep drawn parts without loss of gloss or excessive thinning. The long chain branched polymer provides high melt strength and causes sufficient nucleation to suppress crystallinity of the substantially linear polymer, resulting in high melt strength and drawability.

Melt blending is a preferred method for preparing the final polymer blend. Any techniques for melt blending of a polymer with additives of all types can typically be used with the present invention. Typically, in a melt blending operation, the individual components of the blend are combined in a mechanical extruder or mixer, and then heated to a temperature sufficient to form a polymer melt and effect the reactive modification.

The thermoplastic olefin compositions of this disclosure are generally prepared by melt-mixing in any order: the substantially linear polymer, the long chain branched polymer, the elastomer, and other ingredients (filler, plasticizer, lubricant, stabilizer, etc.) in a mixer heated to above the melting temperature of the polypropylene thermoplastic. Optional fillers, plasticizers, additives, and similar components, can be added at during mixing or later. After sufficient molten-state mixing to form a well mixed blend, the free radical generating agent(s) are generally added.

In an embodiment, the free radical generating agent can be added in solution with a liquid, such as an elastomer processing oil, or in a masterbatch which is compatible with the other components. It is usually desirable to allow the fillers and a portion of any plasticizer to distribute themselves in the elastomer or polymer phase before the addition of free radical generating agent.

Reaction caused by the free radical generating agent can occur in a few minutes or less, depending on the mix temperature, shear rate, and activators present. Suitable melt blending temperatures include from about 170 degrees Centigrade to about 230 degrees Centigrade. More preferred temperatures are from about 190 degrees Centigrade to about 200 degrees Centigrade when the substantially linear polymer and the long chain branched polymer include polypropylene, these preferred temperatures being slightly higher than the complete melting point of polypropylene. While the free radical generating agent can be added at any time, it is preferred to add the free radical generating agent early in the process in order to allow longer mixing times with the polymers and to ensure complete decomposition of the free radical generating agent.

After discharge from the mixer, the blend containing elastomer and the thermoplastic polymers can be milled, chopped, extruded, pelletized, injection-molded, or processed by any other desirable technique.

In an embodiment, the combining of components can include use of a Banbury mixer, a kneader, a single-screw extruder, a twin-screw extruder, a continuous extruder, such as 120 continuous extruder having a length of 100 feet, or other similar means. Use of a twin-screw extruder is preferred due to its capability for continuous production by uniformly and finely dispersing the components and allowing the reactions caused by the free radical generating agent sufficient time to occur.

It is contemplated that the full length of a twin-screw extruder or similar mixing device can be filled with components and heated to ensure complete decomposition of the thermally decomposing free radical generating agent. The mixing process can produce sufficient heat to promote reactivity of the elastomer and the decomposition of the thermally decomposing free radical generating agent, however additional heat can also be provided during the combining of components.

The temperature of the melt, residence time of the melt within the mixer, and the mechanical design of the mixer are several variables that affect the amount of shear to be applied to the composition during mixing. These variables can be readily selected depending on the desired properties of the final product.

As a preferred melt extrusion method, a twin-screw extruder is used which has a length L in the die direction, starting from the starting material adding portion. Suitably, the extruder has a L/D of 30 to 1, where D is the diameter of the barrel. Suitably, the twin-screw extruder has a plurality of feed portions of a main feed portion and a side feed portion, which differ in distance from the tip portion, and has kneading parts between a plurality of the feed portions and between the tip portion and the feed portion nearer from the tip portion.

The twin-screw extruder can be a twin-screw extruder of same direction-revolving type or a twin-screw extruder of different direction-revolving type. The intermeshing of the screws can be any of non-intermeshing type, partial intermeshing type, or complete intermeshing type. When a uniform resin is to be obtained at a low temperature under application of a low shearing force, a different direction-revolving and partial intermeshing type screw is preferred. When a somewhat strong kneading is required, a same direction-revolving and complete intermeshing type screw is preferred. When a further stronger kneading is required, a same direction-revolving and complete intermeshing type screw is preferred.

It is contemplated that the present composition can be pelletized, such as by strand pelleting or commercial underwater pelletization. In one embodiment, articles can be formed directly from the modified blends without intermediate processing steps such as pelleting or shipping. Pellets of the composition can be used to manufacture articles through conventional processing operations, such as thermoforming, that involves stretching and/or drawing. Similar industrial processes involving stretching and/or drawing include extrusions, such as laminated co-extrusions, blow molding, calendaring, solid rod molding, or foam processing. In each of these processes, the melt strength of the polymer is critical to its success, since the melted and/or softened polymer must retain its intended shape while being handled and/or cooled.

During extrusion, for example, a plastic sheet extrusion system is fed by one or more extruders feeding a sheet extrusion die. The die is typically closely followed by a roll cooling system. The resulting, partially cooled sheet can be further cooled on a roller conveyor of finite length.

During calendaring, a sheet is formed by passing material through a series of heated rollers, with the gap between the last pair of heated rollers determining the thickness of the sheet.

Thermoforming includes heating a polymer sheet until it is softened, stretching the sheet over a solid mold having a desired part shape, and allowing the sheet to cool until rigid, so that it retains the shape and detail of the mold.

During blow molding, air pressure is used to expand the melted polymer into hollow shapes. The principal advantage of this process is its ability to produce hollow shapes without having to join two or more separately molded parts.

To produce foamed articles, foaming agents can be included in the mixture. The expanding medium, or foaming agent, can include one or more physical foaming agents, chemical foaming agents, or combinations thereof. A physical foaming agent is a medium expanding composition that is a gas at temperatures and pressures encountered during the foam expanding step. Typically, a physical foaming agent is introduced to the polymer blend in the gaseous or liquid state and expands, for example, upon a rapid decrease in pressure. A chemical foaming agent is a compound or mixture of compounds that decompose at elevated temperatures to form one or more gases, which can be used to expand at least a portion of the polymer blend into a foam.

During form processing, a structure that must hold its shape is developed from melted polymer by the use of blowing agents. A useable extrusion process can include: 1) mixing a thermoplastic material and a blowing agent to form a polymer gel; 2) extruding the gel into a holding zone maintained at a temperature and pressure that does not allow the mixture to foam, the holding zone having a die defining an orifice opening into a zone of lower pressure at which the gel foams and an openable gate closing the die orifice; 3) periodically opening the gate; 4) substantially concurrently applying the mechanical pressure by means of a movable ram on the gel to eject it from the holding zone through the die orifice into the zone of lower pressure; and 5) allowing the ejected gel to expand to form the foam.

Articles that can be manufactured using these and other techniques and the composition of the present invention include interior automotive components, such as instrument panels and bumpers, building materials, packaging materials, electronics materials, nonwoven fabrics and fibers, and other similar materials. In an embodiment, formed articles can be up to about 30 percent translucent and have a flex modulus of about 450.

While these embodiments have been described with emphasis on the embodiments, it should be understood that within the scope of the appended claims, the embodiments might be practiced other than as specifically described herein.

What is claimed is:

1. A thermoplastic olefin composition, comprising:
a) from more than 50 percent up to about 90 percent by weight of polyolefins consisting of:
1) a substantially linear copolymer of propylene; and
2) a long chain branched linear homopolymer of propylene;
b) from about 10 percent to less than about 50 percent by weight of a cross linkable alpha-olefin polymer elastomer; and
c) a thermally decomposing free radical generating agent, wherein the composition is formed by combining the components at a temperature sufficient to melt said polyolefins and elastomer and thermally decompose said agent.

2. The thermoplastic olefin composition of claim 1, wherein the cross linkable alpha-olefin polymer elastomer is selected from the group consisting of: ethylene alpha-olefin polymer elastomer, propylene alpha-olefin polymer elastomer, butylene alpha-olefin polymer elastomer, or combinations thereof.

3. The thermoplastic olefin composition of claim 1, wherein the thermally decomposing free radical generating agent is selected from the group consisting of: a peroxide, an alkyl peroxide, a dialkyl peroxide, a persulfate, a percarbonate, an azo compound of the general formula R₁—N═N—R₂ in which R₁ and R₂ can be the same or different alkane groups, or combinations thereof.

4. The thermoplastic olefin composition of claim 3, wherein the azo compound is present in an amount not exceeding about 1.0 phr of elastomer.

5. The thermoplastic olefin composition of claim 1, wherein the combining of the components comprises melt blending, heating, molding, mixing, or combinations thereof.

6. The thermoplastic olefin composition of claim 5, wherein the combining of the components comprises using a twin-screw extruder or a continuous extruder.

7. A thermoplastic olefin composition, comprising:
a) from more than about 50 percent up to about 90 percent by weight of polyolefins consisting of:
1) a substantially linear homopolymer of propylene; and
2) a long chain branched linear copolymer of propylene;
b) from about 10 percent to less than about 50 percent by weight of a cross linkable alpha-olefin polymer elastomer; and
c) a thermally decomposing free radical generating agent, wherein the composition is formed by combining the components at a temperature sufficient to melt said polyolefins and elastomer and thermally decompose said agent.

8. The thermoplastic olefin composition of claim 7, wherein the cross linkable alpha-olefin polymer elastomer is selected from the group consisting of: ethylene alpha-olefin polymer elastomer, propylene alpha-olefin polymer elastomer, butylene alpha-olefin polymer elastomer, or combinations thereof.

9. The thermoplastic olefin composition of claim 7, wherein the thermally decomposing free radical generating agent is selected from the group consisting of: a peroxide, an alkyl peroxide, a dialkyl peroxide, a persulfate, a percarbonate, an azo compound of the general formula R₁—N═N—R₂ in which R₁ and R₂ can be the same or different alkane groups, or combinations thereof.

10. The thermoplastic olefin composition of claim 9, wherein the azo compound is present in an amount not exceeding about 1.0 phr of elastomer.

11. The thermoplastic olefin composition of claim 7, wherein the combining of the components comprises melt blending, heating, molding, mixing, or combinations thereof.

12. The thermoplastic olefin composition of claim 11, wherein the combining of the components comprises using a twin-screw extruder or a continuous extruder.

13. A thermoplastic olefin composition, comprising:
a) from more than about 50 percent up to about 90 percent by weight of polyolefins consisting of:
1) a substantially linear copolymer of propylene; and
2) a long chain branched linear copolymer of propylene;
b) from about 10 percent to less than about 50 percent by weight of a cross linkable alpha-olefin polymer elastomer; and
c) a thermally decomposing free radical generating agent, wherein the composition is formed by combining the components at a temperature sufficient to melt said polyolefins and elastomer and thermally decompose said agent.

14. The thermoplastic olefin composition of claim 13, wherein the cross linkable alpha-olefin polymer elastomer is selected from the group consisting of: ethylene alpha-olefin polymer elastomer, propylene alpha-olefin polymer elastomer, butylene alpha-olefin polymer elastomer, or combinations thereof.

15. The thermoplastic olefin composition of claim 14, wherein the thermally decomposing free radical generating agent is selected from the group consisting of: a peroxide, an alkyl peroxide, a dialkyl peroxide, a persulfate, a percarbonate, an azo compound of the general formula R₁—N═N—R₂ in which R₁ and R₂ can be the same or different alkane groups, or combinations thereof.

16. The thermoplastic olefin composition of claim 13, wherein the azo compound is present in an amount not exceeding about 1.0 phr of elastomer.

17. The thermoplastic olefin composition of claim 13, wherein the combining of the components comprises melt blending, heating, molding, mixing, or combinations thereof.

18. The thermoplastic olefin composition of claim 17, wherein the combining of the components comprises using a twin-screw extruder or a continuous extruder.
